(19) United States
(12) Patent Application Publication
(10) Pub. No.: US 2024/0356654 A1
(43) Pub. Date: Oct. 24, 2024

(54) SIGNAL AMPLIFICATION METHOD AND OPTICAL RECEIVING APPARATUS

(71) Applicant: NIPPON TELEGRAPH AND TELEPHONE CORPORATION, Tokyo (JP)

(72) Inventors: Toshiaki SHITABA, Musashino-shi, Tokyo (JP); Tomoaki YOSHIDA, Musashino-shi, Tokyo (JP); Yoichi FUKADA, Musashino-shi, Tokyo (JP); Akihiro TANABE, Musashino-shi, Tokyo (JP); Ryo MIYATAKE, Musashino-shi, Tokyo (JP)

(73) Assignee: NIPPON TELEGRAPH AND TELEPHONE CORPORATION, Tokyo (JP)

(21) Appl. No.: 18/683,712

(22) PCT Filed: Aug. 25, 2021
(86) PCT No.: PCT/JP2021/031151

§ 371 Date: Feb. 14, 2024

(51) Int. Cl. H04B 10/54; H04B 10/508; H04J 1/00

(52) U.S. Cl. CPC H04B 10/54; H04B 10/508; H04J 1/00

(57) ABSTRACT

There is provided a signal amplification method executed by an optical reception device, the method including: an electrical conversion step of converting an optical intensity modulation signal according to a frequency modulation signal which is converted from a frequency division multiplexing signal into the frequency modulation signal; a delay control step of controlling a delay amount of the frequency modulation signal based on a center frequency of the frequency modulation signal and a shift amount of a highest frequency of the frequency modulation signal; a delay detection step of demodulating the frequency modulation signal into the frequency division multiplexing signal by executing demodulation processing based on delay detection on the frequency modulation signal of which the delay amount is controlled; an amplification factor derivation step of deriving an amplification factor of the demodulated frequency division multiplexing signal based on the delay amount; and an amplification step of amplifying the demodulated frequency division multiplexing signal by the amplification factor.

### TECHNICAL FIELD

The present invention relates to a signal amplification method and an optical reception device.

### BACKGROUND ART

An optical transmission system using a method of batch-converting a frequency division multiplexing (FDM) signal into a frequency modulation (FM) signal (hereinafter, referred to as an “FM batch-conversion method”) is introduced into a video signal distribution system (refer to Non Patent Literatures 1 and 2).

FIG. 4 is a diagram illustrating a configuration example of an optical transmission system 10. The optical transmission system 10 includes an optical transmission device 11, an optical network 12, and an optical reception device 13. The optical reception device 13 includes an electrical conversion unit 14, a delay detection unit 15, and an amplification processing unit 16.

A frequency division multiplexing signal representing a video signal is input to the optical transmission device 11 from a head end device (not illustrated). The optical transmission device 11 batch-converts a frequency division multiplexing signal representing a video signal into a broadband frequency modulation signal. The optical transmission device 11 converts a broadband frequency modulation signal into an optical intensity modulation signal (optical signal). The optical transmission device 11 transmits the converted optical intensity modulation signal to the optical network 12.

The electrical conversion unit 14 receives the optical intensity modulation signal from the optical network 12. The electrical conversion unit 14 converts the received optical intensity modulation signal into a frequency modulation signal (electrical signal) using a photodiode. In the delay detection unit 15, delay detection is adopted as a demodulation method of the frequency modulation signal. The delay detection unit 15 demodulates the frequency modulation signal into a frequency division multiplexing signal by performing demodulation processing on the frequency modulation signal. The amplification processing unit 16 amplifies an amplitude (a voltage) of the frequency division multiplexing signal representing a video signal to a predetermined level.

### CITATION LIST

### Non Patent Literature

Non Patent Literature 1: ITU-T J. 185: Transmission equipment for transferring multi-channel television signals over optical access networks by frequency modulation conversion.
Non Patent Literature 2: Toshiaki Shitaba and two others, “Optical Video Transmission Technique using FM conversion”, IEICE Technical Report CS2019-84, IE2019-64 (2019-12).

### SUMMARY OF INVENTION

### Technical Problem

As a delay amount “τ” of the frequency modulation signal in the delay detection unit 15 (frequency demodulation unit) increases, a level of the demodulated frequency division multiplexing signal becomes higher. As the level of the demodulated frequency division multiplexing signal becomes higher, an influence of noise in the amplification processing unit 16 is decreased. In this respect, it is desirable that the delay amount “τ” of the frequency modulation signal be set to a maximum. In addition, the delay amount “τ” of the frequency modulation signal needs to be smaller than half of a period “T” of the frequency modulation signal. Here, the delay amount “τ” of the frequency modulation signal in the delay detection unit 15 is a fixed value.

The amplification processing unit 16 extracts a frequency division multiplexing signal having a low frequency from the frequency division multiplexing signal by using a low pass filter (LPF). The amplification processing unit 16 outputs the extracted frequency division multiplexing signal to a display device (not illustrated).

In order to allow the optical reception device 13 to support various optical transmission systems, it is necessary that the optical reception device 13 can execute demodulation processing on a broadband signal normally. In this respect, it is desirable that the delay amount “τ” of the frequency modulation signal be set to a minimum. Thereby, even in a case where a frequency modulation signal having a high frequency is input to the delay detection unit 15, the delay detection unit 15 can execute demodulation processing normally.

As the delay amount “τ” of the frequency modulation signal decreases (as the delay time becomes shorter), the power of the frequency division multiplexing signal demodulated by the delay detection unit 15 decreases. As the power of the frequency division multiplexing signal demodulated by the delay detection unit 15 decreases, an amplification factor of the frequency division multiplexing signal in the amplification processing unit 16 needs to be higher.

However, as the frequency of the frequency modulation signal which is converted by the electrical conversion unit 14 becomes lower, the density of the frequency division multiplexing signal (pulse wave) which is demodulated by the delay detection unit 15 becomes sparser. As the density of the demodulated frequency division multiplexing signal becomes sparser, the power of the demodulated frequency division multiplexing signal decreases. In this case, since the power of the frequency division multiplexing signal which is input from the delay detection unit 15 to the amplification processing unit 16 decreases, an influence of noise in the amplification processing unit 16 increases. As a result, a carrier to noise ratio (CNR) of the frequency division multiplexing signal which is output from the amplification processing unit 16 decreases.

In this way, in a case where the frequency of the frequency modulation signal is low, in some cases, it is difficult to suppress deterioration in quality of the frequency division multiplexing signal which is transmitted using the optical intensity modulation signal.

In view of the above circumstances, an object of the present invention is to provide a signal amplification method and an optical reception device capable of suppressing deterioration in quality of the frequency division multiplexing signal which is transmitted using the optical intensity modulation signal even in a case where the frequency of the frequency modulation signal is low.

### Solution to Problem

According to an aspect of the present invention, there is provided a signal amplification method executed by an optical reception device, the method including: an electrical conversion step of converting an optical intensity modulation signal according to a frequency modulation signal which is converted from a frequency division multiplexing signal into the frequency modulation signal; a delay control step of controlling a delay amount of the frequency modulation signal based on a center frequency of the frequency modulation signal and a shift amount of a highest frequency of the frequency modulation signal; a delay detection step of demodulating the frequency modulation signal into the frequency division multiplexing signal by executing demodulation processing based on delay detection on the frequency modulation signal of which the delay amount is controlled; an amplification factor derivation step of deriving an amplification factor of the demodulated frequency division multiplexing signal based on the delay amount; and an amplification step of amplifying the demodulated frequency division multiplexing signal by the amplification factor.

According to another aspect of the present invention, there is provided an optical reception device including: an electrical conversion unit that converts an optical intensity modulation signal according to a frequency modulation signal which is converted from a frequency division multiplexing signal into the frequency modulation signal; a delay control unit that controls a delay amount of the frequency modulation signal based on a center frequency of the frequency modulation signal and a shift amount of a highest frequency of the frequency modulation signal; a delay detection unit that demodulates the frequency modulation signal into the frequency division multiplexing signal by executing demodulation processing based on delay detection on the frequency modulation signal of which the delay amount is controlled; an amplification factor derivation unit that derives an amplification factor of the demodulated frequency division multiplexing signal based on the delay amount; and an amplification unit that amplifies the demodulated frequency division multiplexing signal by the amplification factor.

### Advantageous Effects of Invention

According to the present invention, even in a case where the frequency of the frequency modulation signal is low, it is possible to suppress deterioration in quality of the frequency division multiplexing signal which is transmitted using the optical intensity modulation signal.

### BRIEF DESCRIPTION OF DRAWINGS

FIG. 1 is a diagram illustrating a configuration example of an optical transmission system according to an embodiment.

FIG. 2 is a flowchart illustrating an operation example of an optical reception device according to the embodiment.

FIG. 3 is a diagram illustrating a hardware configuration example of the optical reception device according to the embodiment.

FIG. 4 is a diagram illustrating a configuration example of an optical transmission system.

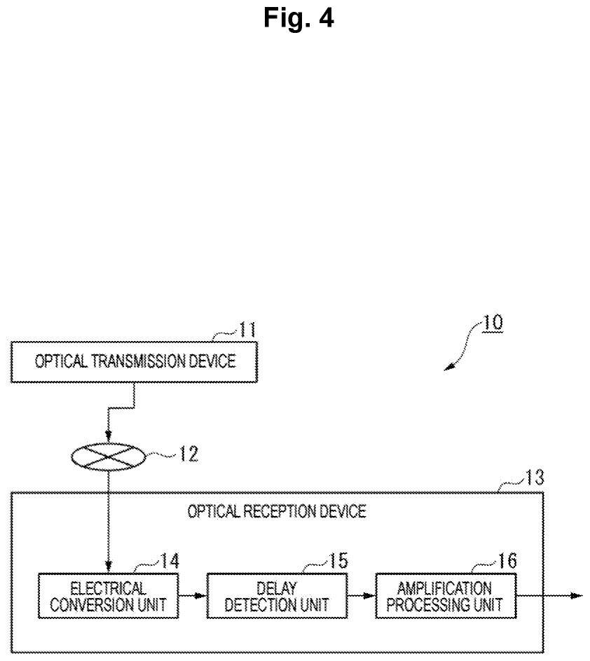

### DESCRIPTION OF EMBODIMENTS

An embodiment of the present invention will be described in detail with reference to the drawings.

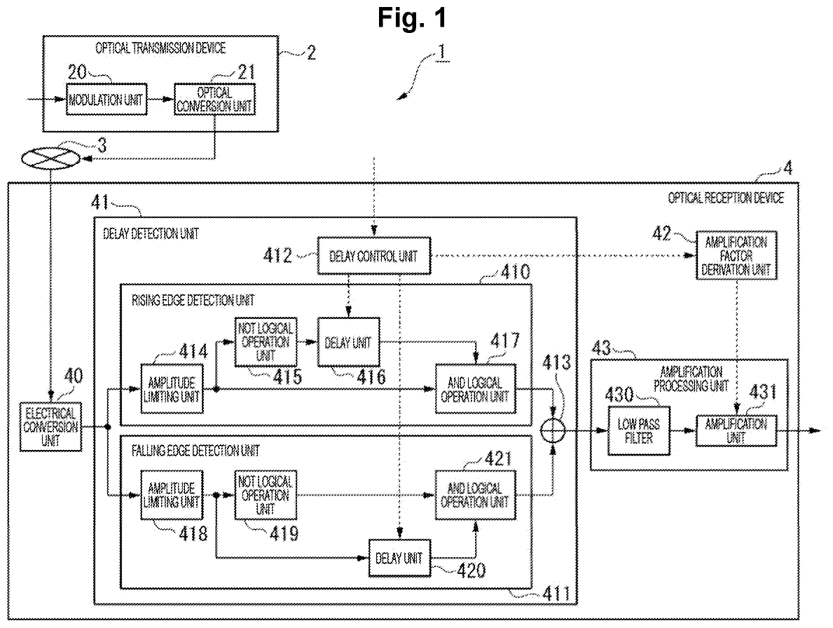

FIG. 1 is a diagram illustrating a configuration example of an optical transmission system 1. The optical transmission system 1 is a system (optical transmission network) that transmits an optical intensity modulation signal.

The optical transmission system 1 includes an optical transmission device 2, an optical network 3, and an optical reception device 4. The optical transmission device 2 includes a modulation unit 20 and an optical conversion unit 21.

The optical reception device 4 includes an electrical conversion unit 40, a delay detection unit 41, an amplification factor derivation unit 42, and an amplification processing unit 43. The delay detection unit 41 includes a rising edge detection unit 410, a falling edge detection unit 411, a delay control unit 412, and an addition unit 413.

The rising edge detection unit 410 includes an amplitude limiting unit 414, a NOT logical operation unit 415, a delay unit 416, and an AND logical operation unit 417. The falling edge detection unit 411 includes an amplitude limiting unit 418, a NOT logical operation unit 419, a delay unit 420, and an AND logical operation unit 421. The amplification processing unit 43 includes a low pass filter 430 and an amplification unit 431.

The optical transmission device 2 is, for example, an optical subscriber line terminal such as a video-optical line terminal (V-OLT). An input signal (main signal) is input to the optical transmission device 2 from a first external device (not illustrated). The first external device (not illustrated) is, for example, a head end device. In the following, the input signal is a video signal as an example. The optical transmission device 2 transmits, as a transmission signal, a frequency division multiplexing signal (FDM signal) representing a video signal to the optical network 3.

The optical transmission device 2 batch-converts the frequency division multiplexing signal into a frequency modulation signal (FM signal) based on an FM batch-conversion method. Thereby, the optical transmission device 2 generates a broadband frequency modulation signal. The broadband is not limited to a specific band. For example, the broadband is a band having a center frequency of approximately 3 GHz, and is, for example, a band from approximately 500 MHz (lowest frequency) to approximately 6 GHz (highest frequency). The optical transmission device 2 converts the generated frequency modulation signal into an optical intensity modulation signal that is an optical signal of which the optical intensity is modulated. The optical transmission device 2 transmits the optical intensity modulation signal to the optical network 3.

In the optical network 3, an optical amplifier (not illustrated) such as an erbium-doped fiber amplifier (EDFA) and an optical distributor (not illustrated) are connected in multiple stages. Thereby, the optical network 3 can transmit a broadband optical intensity modulation signal to the optical reception device 4.

The optical reception device 4 is, for example, an optical line termination device such as a video-optical network unit (V-ONU). The optical reception device 4 receives the optical intensity modulation signal from the optical network 3. The optical reception device 4 converts the optical intensity modulation signal (optical signal) into a frequency modulation signal (electrical signal) using a photodiode.

The optical reception device 4 demodulates the frequency modulation signal into a frequency division multiplexing signal by performing demodulation processing based on a delay detection method on the frequency modulation signal. The demodulation processing based on a delay detection method includes processing of detecting a rising edge of the frequency modulation signal and processing of detecting a falling edge of the frequency modulation signal.

The optical reception device 4 changes a delay amount of the frequency modulation signal in the delay unit 416 according to the frequency of the demodulated frequency modulation signal. For example, the optical reception device 4 changes a delay amount “τ” of the frequency modulation signal in the delay unit 416 based on information on a center frequency of the frequency modulation signal (hereinafter, referred to as “center frequency information”) and information on a shift amount (offset amount) of a highest frequency with respect to the center frequency of the frequency modulation signal (hereinafter, referred to as “shift amount information”). In this manner, the optical reception device 4 dynamically changes a band of the demodulation processing on the frequency modulation signal according to the frequency of the frequency modulation signal.

The optical reception device 4 derives an amplification factor of the frequency division multiplexing signal, which is demodulated by the delay detection unit 41, according to the delay amount of the frequency modulation signal in the delay unit 416. The optical reception device 4 changes the amplification factor of the frequency division multiplexing signal in the amplification unit 431 based on amplification factor information of the frequency division multiplexing signal. That is, the optical reception device 4 amplifies an amplitude (a voltage) of the frequency division multiplexing signal based on the amplification factor information of the frequency division multiplexing signal. The optical reception device 4 outputs the frequency division multiplexing signal to a second external device (not illustrated).

The second external device is, for example, a display device. The display device (not illustrated) acquires, from the optical reception device 4, the frequency division multiplexing signal of which the amplitude (voltage) is amplified according to the amplification factor information. The display device displays a video on a screen according to a video signal included in the frequency division multiplexing signal.

Next, details of the optical transmission device 2 and the optical reception device 4 will be described.

A frequency division multiplexing signal including a video signal is input to the modulation unit 20 (frequency modulation unit) from a head end device (not illustrated). The modulation unit 20 batch-converts the frequency division multiplexing signal including a video signal into a broadband frequency modulation signal based on an FM batch-conversion method.

The optical conversion unit 21 (optical intensity modulator) converts the broadband frequency modulation signal (electrical signal) into an optical intensity modulation signal (optical signal) using a laser oscillator (not illustrated). The optical conversion unit 21 transmits the optical intensity modulation signal to the optical network 3.

The electrical conversion unit 40 receives the optical intensity modulation signal from the optical network 3. The electrical conversion unit 40 converts the optical intensity modulation signal (optical signal) into a frequency modulation signal (electrical signal) using a photodiode. The electrical conversion unit 40 branches the frequency modulation signal into two systems of the rising edge detection unit 410 and the falling edge detection unit 411.

The delay control unit 412 acquires the shift amount information and the center frequency information. For example, the delay control unit 412 acquires shift amount information and center frequency information which are directly input by a network administrator or the like who operates a touch panel or the like. For example, the delay control unit 412 may acquire predetermined shift amount information and predetermined center frequency information from an information processing device (not illustrated) connected to another optical network (not illustrated). For example, the delay control unit 412 may extract, from the demodulated frequency division multiplexing signal, shift amount information and center frequency information which are superimposed on the frequency division multiplexing signal by the optical transmission device 2.

The delay control unit 412 derives a delay amount “τ” of the frequency modulation signal in the delay unit 416 based on the shift amount information and the center frequency information. A width of each of pulse waves of the demodulated frequency division multiplexing signal is equal to the delay amount of the frequency modulation signal. The delay control unit 412 derives a delay amount such that a width of each of the pulse waves of the demodulated frequency division multiplexing signal becomes maximum within a range in which the pulse waves do not overlap each other. The delay control unit 412 outputs information on the derived delay amount to the amplification factor derivation unit 42.

The amplification factor derivation unit 42 controls the amplification factor of the frequency division multiplexing signal in the amplification factor derivation unit 42 based on a predetermined relationship between the delay amount and the amplification factor. Note that the predetermined relationship may be theoretically derived or experimentally derived.

The amplitude limiting unit 414 acquires, from the electrical conversion unit 40, one frequency modulation signal which is branched by the electrical conversion unit 40. The amplitude limiting unit 414 rectangularizes the acquired frequency modulation signal by limiting the amplitude of the acquired frequency modulation signal. Thereby, the frequency modulation signal which is output from the amplitude limiting unit 414 becomes a pulse wave. The amplitude limiting unit 414 outputs the rectangularized frequency modulation signal to the NOT logical operation unit 415 and the AND logical operation unit 417.

The NOT logical operation unit 415 (NOT gate) acquires, from the amplitude limiting unit 414, one frequency modulation signal which is branched by the amplitude limiting unit 414. The NOT logical operation unit 415 performs a NOT logical operation on the acquired frequency modulation signal. The delay unit 416 acquires delay amount information from the delay control unit 412. The delay unit 416 delays the frequency modulation signal on which the NOT logical operation is performed by the delay amount “τ” based on the delay amount information.

The AND logical operation unit 417 (AND gate) acquires, from the amplitude limiting unit 414, the other frequency modulation signal which is branched by the amplitude limiting unit 414. The AND logical operation unit 417 acquires, from the delay unit 416, the frequency modulation signal on which the NOT logical operation is performed and which is delayed. The AND logical operation unit 417 outputs, as a detection result, a result of an AND logical operation of the frequency modulation signal and the frequency modulation signal on which the NOT logical operation is performed and which is delayed (a sequence of pulse waves having a width of the delay amount “τ”) to the addition unit 413.

The amplitude limiting unit 418 acquires, from the electrical conversion unit 40, the other frequency modulation signal which is branched by the electrical conversion unit 40. The amplitude limiting unit 418 rectangularizes the frequency modulation signal by limiting the amplitude of the acquired frequency modulation signal. Thereby, the frequency modulation signal which is output from the amplitude limiting unit 418 becomes a pulse wave. The amplitude limiting unit 418 outputs the rectangularized frequency modulation signal to the NOT logical operation unit 419 and the delay unit 420.

The NOT logical operation unit 419 (NOT gate) acquires, from the amplitude limiting unit 418, one frequency modulation signal which is branched by the amplitude limiting unit 418. The NOT logical operation unit 419 performs a NOT logical operation on the acquired frequency modulation signal.

The delay unit 420 acquires, from the amplitude limiting unit 418, the other frequency modulation signal which is branched by the amplitude limiting unit 418. The delay unit 420 acquires delay amount information from the delay control unit 412. The delay unit 420 delays the frequency modulation signal acquired from the amplitude limiting unit 418 by the delay amount “τ” based on the delay amount information.

The AND logical operation unit 421 (AND gate) acquires, from the NOT logical operation unit 419, the frequency modulation signal on which the NOT logical operation is performed. The AND logical operation unit 421 acquires the delayed frequency modulation signal from the delay unit 420. The AND logical operation unit 421 outputs, as a detection result, a result of an AND logical operation of the delayed frequency modulation signal and the frequency modulation signal on which the NOT logical operation is performed (a sequence of pulse waves having a width of the delay amount “τ”) to the addition unit 413.

The addition unit 413 (OR gate) acquires, from the AND logical operation unit 417, the result of the AND logical operation of the frequency modulation signal and the frequency modulation signal on which the NOT logical operation is performed and which is delayed. The addition unit 413 acquires, from the AND logical operation unit 421, the result of the AND logical operation of the delayed frequency modulation signal and the frequency modulation signal on which the NOT logical operation is performed.

The addition unit 413 adds the result of the AND logical operation of the frequency modulation signal and the frequency modulation signal on which the NOT logical operation is performed and which is delayed and the result of the AND logical operation of the delayed frequency modulation signal and the frequency modulation signal on which the NOT logical operation is performed. The addition unit 413 outputs, as a demodulated frequency division multiplexing signal (demodulated signal), an addition result by the addition unit 413 to the low pass filter 430.

The low pass filter 430 (LFP) extracts a frequency division multiplexing signal having a low frequency from the demodulated frequency division multiplexing signal (demodulated signal). The amplification unit 431 outputs the frequency division multiplexing signal having a low frequency to a display device (not illustrated).

Next, an operation example of the optical reception device 4 will be described.

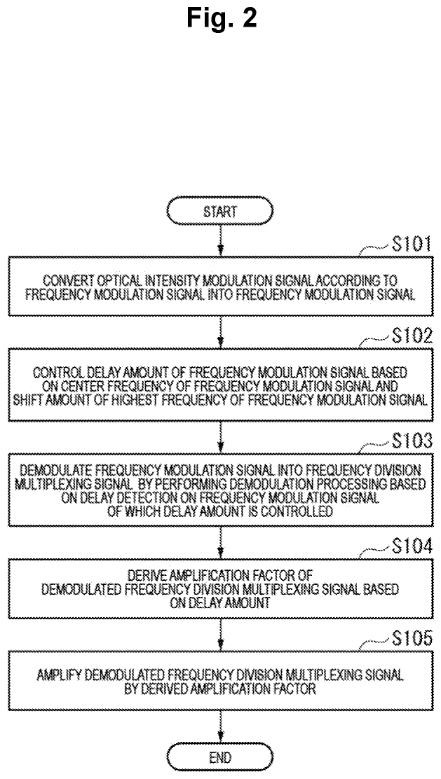

FIG. 2 is a flowchart illustrating an operation example of the optical reception device 4 according to the embodiment. The electrical conversion unit 40 converts the optical intensity modulation signal according to the frequency modulation signal into a frequency modulation signal (step S101). The delay control unit 412 controls the delay amount of the frequency modulation signal based on the center frequency of the frequency modulation signal and the shift amount of the highest frequency of the frequency modulation signal (step S102).

The delay detection unit 41 (frequency demodulation unit) demodulates the frequency modulation signal into a frequency division multiplexing signal by performing demodulation processing based on delay detection on the frequency modulation signal of which the delay amount is controlled (step S103). The amplification factor derivation unit 42 derives an amplification factor of the demodulated frequency division multiplexing signal based on the delay amount of the frequency modulation signal (step S104). The amplification processing unit 43 amplifies the demodulated frequency division multiplexing signal by the derived amplification factor (step S105).

As described above, the electrical conversion unit 40 converts the optical intensity modulation signal (optical signal) according to the frequency modulation signal, which is converted from the frequency division multiplexing signal, into the frequency modulation signal (electrical signal). The delay control unit 412 controls the delay amount of the frequency modulation signal based on the center frequency of the frequency modulation signal and the shift amount of the highest frequency of the frequency modulation signal. The delay detection unit 41 performs demodulation processing based on delay detection on the frequency modulation signal of which the delay amount is controlled. Thereby, the delay detection unit 41 demodulates the frequency modulation signal into a frequency division multiplexing signal. The amplification factor derivation unit 42 derives an amplification factor of the demodulated frequency division multiplexing signal based on the delay amount of the frequency modulation signal. The amplification unit 431 amplifies the demodulated frequency division multiplexing signal by the derived amplification factor.

Even in a case where a frequency modulation signal having a low frequency is input to the optical reception device 4, an allowable maximum delay amount (an allowable longest delay time) is dynamically set for the delay unit 416, and thus it is possible to maintain the intensity of the signal which is input to the amplification unit 431 to be high. In addition, the amplification factor of the signal which is input to the amplification unit 431 is dynamically changed according to the delay amount in the delay unit 416.

As described above, a frequency demodulation band of the optical reception device 4 is dynamically changed according to the frequency of the frequency modulation signal. Thus, even in a case where the frequency of the frequency modulation signal is low (for example, in a case where the frequency of the frequency modulation signal is equal to or lower than a predetermined threshold value), it is possible to suppress deterioration in quality of the frequency division multiplexing signal which is transmitted using the optical intensity modulation signal. An optical reception device that can be commonly used in a plurality of optical transmission systems is realized, and thus it is possible to realize an economical optical transmission system. It is possible to realize an optical transmission system with high versatility. It is possible to suppress an influence of noise in the amplification unit 431, and to suppress a fluctuation in power of the signal which is output from the optical reception device 4.

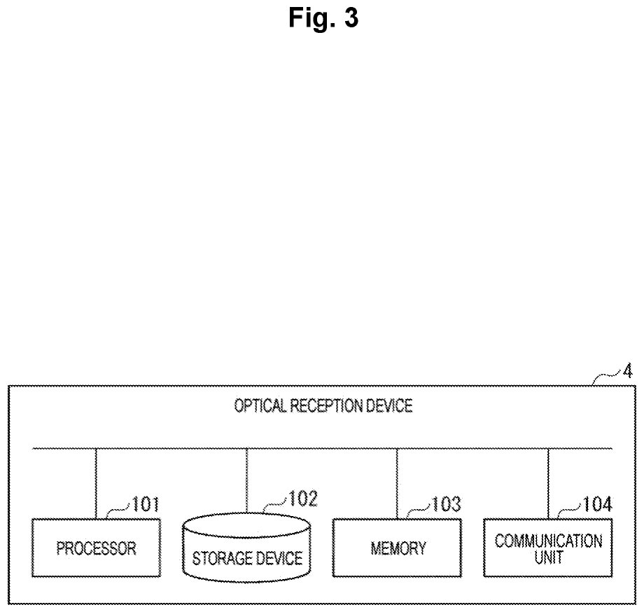

FIG. 3 is a diagram illustrating a hardware configuration example of the optical reception device 4 according to the embodiment. Some or all of the delay detection unit 41, the amplification factor derivation unit 42, and the amplification processing unit 43 of the optical reception device 4 are realized as software by causing a processor such as a central processing unit (CPU) to execute a program stored in a storage device including a non-volatile recording medium (non-transitory recording medium) and a memory. The program may be recorded in a computer-readable recording medium. The computer-readable recording medium is, for example, a portable medium such as a flexible disk, a magneto-optical disc, a read-only memory (ROM), or a compact disc read-only memory (CD-ROM), or a non-transitory recording medium such as a storage device such as a hard disk provided in a computer system.

Some or all of the delay detection unit 41, the amplification factor derivation unit 42, and the amplification processing unit 43 of the optical reception device 4 may be implemented by using hardware including an electronic circuit (electronic circuit or circuitry) using, for example, a large scale integrated circuit (LSI), an application specific integrated circuit (ASIC), a programmable logic device (PLD), a field programmable gate array (FPGA), or the like.

As described above, the embodiment of the present invention has been described in detail with reference to the drawings. On the other hand, specific configurations are not limited to the embodiment, and include design and the like within the scope of the present invention without departing from the gist of the present invention.

### Industrial Applicability

The present invention can be applied to a distribution system of a video signal or the like.

### Reference Signs List

1 Optical transmission system
2 Optical transmission device
3 Optical network
4 Optical reception device
10 Optical transmission system
11 Optical transmission device
12 Optical network
13 Optical reception device
14 Electrical conversion unit
15 Delay detection unit
16 Amplification processing unit
20 Modulation unit
21 Optical conversion unit
40 Electrical conversion unit
41 Delay detection unit
42 Amplification factor derivation unit
43 Amplification processing unit
410 Rising edge detection unit
411 Falling edge detection unit
412 Delay control unit
413 Addition unit
414 Amplitude limiting unit
415 NOT logical operation unit
416 Delay unit
417 AND logical operation unit
418 Amplitude limiting unit
419 NOT logical operation unit
420 Delay unit
421 AND logical operation unit
430 Low pass filter
431 Amplification unit

1. A signal amplification method executed by an optical reception device, the method comprising:
an electrical conversion step of converting an optical intensity modulation signal according to a frequency modulation signal which is converted from a frequency division multiplexing signal into the frequency modulation signal;
a delay control step of controlling a delay amount of the frequency modulation signal based on a center frequency of the frequency modulation signal and a shift amount of a highest frequency of the frequency modulation signal;
a delay detection step of demodulating the frequency modulation signal into the frequency division multiplexing signal by executing demodulation processing based on delay detection on the frequency modulation signal of which the delay amount is controlled;
an amplification factor derivation step of deriving an amplification factor of the demodulated frequency division multiplexing signal based on the delay amount; and
an amplification step of amplifying the demodulated frequency division multiplexing signal by the amplification factor.

2. The signal amplification method according to claim 1, wherein
a width of each of pulse waves of the demodulated frequency division multiplexing signal is equal to the delay amount, and
the delay control step includes deriving the delay amount such that a width of each of the pulse waves becomes maximum within a range in which the pulse waves do not overlap each other.

3. An optical reception device comprising:
a processor; and
a storage medium having computer program instructions stored thereon, when executed by the processor, perform to:
converts an optical intensity modulation signal according to a frequency modulation signal which is converted from a frequency division multiplexing signal into the frequency modulation signal;
controls a delay amount of the frequency modulation signal based on a center frequency of the frequency modulation signal and a shift amount of a highest frequency of the frequency modulation signal;
demodulates the frequency modulation signal into the frequency division multiplexing signal by executing demodulation processing based on delay detection on the frequency modulation signal of which the delay amount is controlled;
derives an amplification factor of the demodulated frequency division multiplexing signal based on the delay amount; and
amplifies the demodulated frequency division multiplexing signal by the amplification factor.

4. The optical reception device according to claim 3, wherein
a width of each of pulse waves of the demodulated frequency division multiplexing signal is equal to the delay amount, and the computer program instructions further perform to derives the delay amount such that a width of each of the pulse waves becomes maximum within a range in which the pulse waves do not overlap each other.
